(19) United States
(12) Patent Application Publication
(10) Pub. No.: US 2015/0265951 A1
(43) Pub. Date: Sep. 24, 2015

(54) Filtering Device for the Filtration of Wastewater

(71) Applicant: HUBER SE, Berching (DE)

(72) Inventors: Christian Frommann, Neumarkt (DE); Stefan Reber, Nurnberg (DE); Alexander Merkl, Roth (DE)

(21) Appl. No.: 14/662,445

(22) Filed: Mar. 19, 2015

(30) Foreign Application Priority Data
Mar. 20, 2014 (DE) 10 2014 103 831.2

(51) Int. Cl. B01D 29/64

(52) U.S. Cl. CPC B01D 29/6438

(57) ABSTRACT

The invention refers to a filter device for filtering sewage, wherein the filter device has a drum (16) pivoted around a rotation axis (1), wherein the filter device has numerous filter disks (2) running parallel to one another, attached to the drum (16) and that can be made to rotate together with it with the help of a driving device (3), whereby the filter disks (2) have, in each case, filter surfaces (4) running parallel to one another that delimit several hollow spaces (5) arranged in circumferential direction of the respective filter disk (2) and preferably in fluid connection to one another, in which case the hollow spaces (5) are in fluid connection with the drum (6) through one or several inlet openings (6), so that the liquid to be filtered can flow out to the exterior, starting from the interior of the drum (16) through the inlet openings (6) into the hollow spaces (5) and the filtrate can flow from there to the exterior via the filter surfaces (4). According to the invention, it is recommended that the filter surfaces (4) are formed at least partially by a filter material (22) that comprises a supporting layer and numerous individual fibers attached to the supporting layer, and that the filter device has at least one high-pressure cleaning nozzle (7) movable in the direction of the rotation axis (1) used to spray the outer surfaces (13) of the filter disks (2) facing away from the respective hollow spaces (5) with a liquid in order to clean the filter material (22) in reverse flow.

The present invention refers to a filter device that has a drum pivoted around a rotation axis, wherein the filter device has numerous filter disks attached to the drum running parallel to one another that can be made to rotate together with it with the help of a driving device, in which case the filter disks have in each case two filter surfaces running parallel to one another that delimit several hollow spaces arranged in circumferential direction of the respective filter disk and are preferably in fluid connection with one another, in which case the hollow spaces are in a fluid connection with the drum through one or several inlet openings, so that the sewage to be filtered can flow starting from the interior of the drum through the inlet openings into the hollow spaces and the filtrate (i.e. the proportion of sewage that can pass the filter surfaces) can flow from there through the filter surfaces towards the exterior.

Generic filter devices are known and serve to filter sewage, i.e. water containing the most varied impurities that should be held back during filtration. Generally, woven film materials are used in the filter devices, mostly known as disk filters. However, owing to the manufacturing process, they have a certain minimum pore size and because of this, the filtrate that forms during the corresponding filtration still contains some impurities.

The task of the present invention is therefore to suggest a filter device able to remove from the sewage particles with a maximum diameter in the μm range, in which case the filter device should allow an easy cleaning of the filter surfaces, on which the sewage impurities held back during filtration collect.

The task is solved by a filter device having the characteristics of the independent patent claim.

Basically, the filter device has a central drum on which numerous filter disks are attached and that can be rotated with the help of a driving device. Preferably, each filter disk has two filter surfaces running parallel to one another that extend annularly and concentrically with the drum around it, whereby the filter surfaces are in each case arranged preferably on a plane running perpendicularly to the drum's rotation axis. The individual filter surfaces can be executed as one single part or also as several parts. Preferably, each filter surface consists of individual filter sections (preferably executed trapeze-shaped for the most part), in which case the filter sections can be separated and held from one another in circumferential direction of the respective filter surface, for example, by supports pointing outwards radially from the drum.

It is additionally advantageous if the filter surfaces are executed flat, whereby the hollow spaces of the filter disks laterally delimited by the filter surfaces of the individual filters can be delimited in radial direction by closing elements running externally (e.g. in form of cover elements) that run preferably concentrically with the drum. The hollow spaces can be connected to one another with fluid in circumferential direction, so that the individual hollow spaces of a filter disk should not be assumed to be fully closed areas. Rather, the drum has many inlet openings through which the sewage from the inside of the drum that must be filtered can flow into the corresponding hollow spaces. From there, the filtrate flows through the filter surfaces on both sides to the exterior and can finally be removed from the filter device through a respective discharge pipe. The retained material (i.e. the impurities held back by the filter surfaces inside the filter disks) collects in reverse on the inner sides or inside of the filter surfaces and must be cleaned from them from time to time, as will still be described in more detail below.

According to the invention, the filter device is characterized by the fact that the filter surfaces are formed (at least partially) by filter material that comprises a support layer and many individual fibers attached to the support layer. The support layer can be formed, for example, by one or several woven fiber layers with which the corresponding individual fibers can be attached (e.g. glued, bonded or tied) to one another. The individual fibers can be present, for example, as fleece (i.e. as tangled fabric made from numerous individual fibers), which is partially woven into the support layer or also otherwise attached to it. Whereas the support layer serves to stabilize the filter material, the individual fibers form most of the actual filter layer in which the impurities from the sewage to be filtered collect and are thus held back as retained material.

According to the invention, it is additionally suggested that the filter devices should have at least one high-pressure cleaning nozzle movable in the direction of the rotation axis, used to spray the exterior surfaces of the filter disks facing away from the corresponding hollow spaces with a liquid to clean the filter material in reverse flow. The liquid is thus sprayed on the filter material from the outside and penetrates it in the direction of the respective hollow spaces, while the filtrate flows out to the outside through the filter material, starting from the hollow spaces, during the course of filtration. The high-pressure cleaning nozzle can comprise one or several spray heads directed at one or several filter disks and used, for example, to spray the cleaning liquid in filtrate form directly on the filter disks. Within the framework of this invention, the term “high-pressure cleaning nozzle” is understood to be a liquid nozzle that, with the help of the respective supply of liquid (which can also comprise, among other things, a corresponding liquid pump), sprays during a high-pressure cleaning cycle with a liquid pressure amounting to at least 30 bar. Finally, during the high-pressure cleaning cycle mentioned above, the high-pressure cleaning nozzle can be moved towards the rotation axis so that it can be successively adjusted towards to all filter surfaces. In other words, the high-pressure cleaning nozzle can thus be moved from one filter disk to another so it can clean all filter disks in succession.

In this case, it is especially advantageous if the filter material is executed as needle felting, as this material has a support layer—especially in form of a support fabric—with which the individual fibers are attached through needling. During the manufacture of the needle felting, the individual fibers are introduced partially into the support layer and anchored in it with a process known from the state of the art to create an effective three-dimensional filter medium. Compared to exclusively woven filter materials, needle felting has a much larger filter surface due to its very fine and pronounced pore structure and the relatively large pore volume to achieve extremely high selectivity.

In this context, it is advantageous if the high-pressure cleaning nozzle can be moved towards the rotation axis with the help of a first drive, and on a plane running perpendicularly to the rotation axis with the help of a second drive, so that the filter material of the individual filter disks can be cleaned in succession individually or as a group. In this case, the high-pressure cleaning nozzle is adjusted to a first filter disk with the help of the first drive and then in radial direction to the drum's rotation axis or tilted to it with the help of the second drive, so that the external surfaces of the filter material are sprayed spirally with liquid when the filter disks are rotating. When the high-pressure cleaning nozzle has reached the vicinity of the drum, it is moved once again outwards so it can be moved afterwards to the next filter disk in the direction of the rotation axis, in which case the latter movement takes place once again with the help of the first drive. Ultimately, it is possible to clean all filter surfaces in reverse flow with the high-pressure cleaning nozzle during the course of the high-pressure cleaning cycle.

It is advantageous if the filter material comprises synthetic fibers, e.g. polyester fibers, polypropylene fibers and/or polyamide fibers, and if the filter material is preferably reinforced mechanically. The respective fibers resist mechanical stress and chemical exposure, so the filter device can also be used for filtering aggressive sewage. It is especially conceivable to use a mix of different types of fiber, in which case—particularly when needle felting is used—the support layer mentioned above (in form of a support woven fabric, for example) and the fibers from various materials needled with it can be made from different materials. Needless to say, the fleece already mentioned and the corresponding support layer can be made from different types of fiber.

It is additionally advantageous if each one of the filter surfaces comprise several filter segments arranged in circumferential direction of the individual filter disks and the individual filter segments comprise in each case a supporting frame and filler material combined with the supporting frame, The filter material can be, for example, bonded or glued to the supporting frame (which can be made wholly or partially from plastic). A clamping attachment is conceivable too. In addition, the supporting frame should be arranged only in the edge area of the respective filter segment to maximize the filter surface. Finally, the individual segments can be attached to a support of the filter device or held by it through the corresponding grooves, for example. The supports can extend radially to the exterior starting from the drum and be attached to it with screws or straps. Moreover, each filter disk should comprise two support assemblies running parallel so that the filter segments can be arranged around the drum in form of two circular rings and thus delimit from the side the above-mentioned hollow spaces of the corresponding filter disk. Finally, the parallel-running support assemblies of a filter disk can be attached to the cover elements mentioned above in their radial outer area, through which they delimit the hollow spaces in radial direction towards the exterior and the filter segments are fixed in place.

It is furthermore particularly advantageous if one or several low-pressure cleaning nozzles are assigned to the individual filter surfaces. With the help of the former, the external surfaces of the filter disks that face away from the corresponding hollow spaces are sprayed with a liquid to clean the filter material in reverse flow. Within the framework of the invention, the term “low-pressure cleaning nozzle” is understood to be a liquid nozzle that, with the help of a corresponding supply of liquid (which can comprise, among other things, a respective liquid pump), impinges with a maximum liquid pressure of 25 bar during a low-pressure cleaning cycle. In this case, the filter device comprises two cleaning systems that are operated with different pressures (whereby, incidentally, the supply of liquid can be operationally connected with the two systems; alternately, it is naturally possible to also have two separate supplies of liquid and especially separate liquid pumps too for the high- and low-pressure cleaning nozzles). The low-pressure cleaning nozzles can be arranged rigidly on a corresponding supporting device and serve to clean the filter material more or less continuously. For example, it could be conceivable to activate the low-pressure cleaning nozzles at least every five, preferably every three rotations of the filter disks in order to make clogging of the filter material more difficult. Contrary to this, the high-pressure cleaning nozzles serve to clean the filter material intensively, since the liquid being sprayed from them with high pressure penetrates the filter material especially well and therefore carries impurities that have also reached the interior of the filter material too (i.e. towards the hollow spaces). In any case, a discharge device (shaped like a gutter, for example) should be placed in the interior of the drum so the impurities that the individual cleaning nozzles have removed from the filter material can fall and then be removed from the filter device (for this reason, the respective cleaning nozzles are located preferably above the drum's rotation axis).

It is also extremely advantageous if at least one low-pressure cleaning nozzle is assigned to each filter surface, so that all filter surfaces can be cleaned at the same time. In this case, the low-pressure cleaning nozzles can be arranged in a stationary way. In addition, numerous low-pressure cleaning nozzles can be assigned to each filter disk or each filter surface, through which the cleaning fluid can flow out. If the individual low-pressure cleaning nozzles are placed between the outer perimeter of the respective filter disk and the drum, then the entire external surface of the filter material is sprayed with the cleaning liquid when the filter disks rotate around the drum's rotation axis.

It is additionally advantageous if a supply of liquid connects the high-pressure cleaning nozzle and the low-pressure cleaning nozzles, in which case the supply of liquid is designed to impinge the high-pressure cleaning nozzle with a liquid pressure ranging from 30 bar to 220 bar, preferably from 40 bar to 200 bar, and ideally from 50 bar to 180 bar. Depending on the filter material used, the pressures mentioned above ensure that the filter material is freed from impurities in an intensive way when the high-pressure cleaning nozzle is activated (i. e. when the latter is supplied with a cleaning liquid that can be the filtrate of the filter device or fresh water). The original filter effectiveness or the original filter throughput of the filter material is restored as a result of this. It is also advantageous if the supply of liquid is designed to impinge the low-pressure cleaning nozzles with a liquid pressure amounting to between 1 bar and 25 bar, preferably between 1 bar and 20 bar, and ideally between 1 bar and 15 bar. Due to the relatively low pressure, many low-pressure cleaning nozzles can be used, supplied simultaneously with a single liquid pump filled with liquid. The supply of liquid can comprise separate liquid pumps and separate liquid pipes for the high- and low-pressure cleaning nozzles, so that both types of nozzle can be operated independently from one another. Alternately, the individual liquid pumps and liquid pipes can also be used partially for the two types of nozzle so that, for example, one liquid pump that according to specification can generate different liquid pressures by a control and the position of the corresponding liquid switches in order to supply either the high-pressure cleaning nozzle or the low-pressure cleaning nozzles with liquid of different pressures can be enough.

It is also extremely advantageous if the filter device has a control designed to activate the high-pressure cleaning nozzle and/or the low-pressure cleaning nozzles only when the drum—and with it, the filter disks too—can be rotated with the help of the driving device. This effectively prevents the corresponding cleaning nozzles from being directed too long on a surface section of the respective filter material, thereby damaging it. Moreover, the rotation of the filler disks ensures that all their external surfaces are sprayed with the corresponding cleaning liquid. The control can also be designed to turn off the respective liquid pumps during a cleaning cycle. This makes sense when the rotation of the drum is also interrupted for some reason.

It is likewise advantageous if the filter device has a control designed to activate the high-pressure cleaning nozzle and/or the low-pressure cleaning nozzles simultaneously or in a time-displaced way to one another. Especially preferred is a staggered operation in which the high-pressure cleaning nozzles must be activated a lot less than the low-pressure cleaning nozzles, since intensive cleaning is necessary only in longer intervals (while the low-pressure cleaning nozzles should, for example, be often be impinged with liquid at least more than 50% of the time in which the filter disks rotate to counteract an excessive penetration of impurities into the filter material).

It is also advantageous for the filter device to have a control designed to reactivate the high-pressure cleaning nozzle in 1 operating hour at the earliest, preferably in 3 operating hours at the earliest, ideally in 5 operating hours at the earliest, after a high-pressure cleaning cycle has been completed. One high-pressure cleaning cycle comprises the cleaning of the entire external area of the filter materials through the corresponding movement of the cleaning nozzle by the above-mentioned drives. If the high-pressure cleaning nozzle would be activated more often, then this would consume excessive energy and the filter material would be especially exposed to high mechanical stress. However, it is also advantageous if the control is designed to reactivate the high-pressure cleaning nozzle in 15 operating hours at the latest, preferably in 11 operating hours at the latest, ideally in 8 operating hours at the latest, after a high-pressure cleaning cycle has been completed. This prevents the overload of the filter material with impurities held back from the sewage (something that would eventually cause a significant reduction of the filter performance of the filter device). By the way, the term “operating hours” is understood to be the time during which the filter disks are rotating to bring about the filtration of the sewage. It should also be pointed out that the high-pressure cleaning cycle can by all means be interrupted (for example, because the filter disks stop rotating for a while).

It is advantageous if the filter device has a control designed to activate the high-pressure cleaning nozzle at the earliest when the filter surfaces were fully cleaned with the help of the low-pressure cleaning nozzles 45 times, preferably 135 times, very preferably 225 times, and/or when the control is designed to activate the high-pressure cleaning nozzle at the latest when the filter surfaces were fully cleaned with the help of the low-pressure cleaning nozzles 675 times, preferably 495 times, very preferably 360 times. If each one of the low-pressure cleaning nozzles has many cleaning nozzles arranged in such a way so they are able to spray one filter disk in radial direction fully with liquid, then a low-pressure cleaning cycle, i.e. a full cleaning of the surface disks, is completed after they have rotated once. If the number of completed full cleaning processes lies between the above-mentioned limits, then a high-pressure cleaning cycle is started to clean the filter material intensively.

It is also extremely advantageous if the drum's driving device is designed to rotate the drum while the filter device is operating with a speed between 0.5 rpm and 10.0 rpm, preferably between 1.0 rpm and 5.0 rpm. The appropriate values ensure high filtration performance with acceptable energy consumption. Additionally, the maximum rpm amount indicated ensures that the liquid jet generated by the respective cleaning nozzles is directed long enough on a certain filter section of the filter materials to make the corresponding cleaning in reverse flow possible. Finally, the minimum rpm mentioned above ensures that the mechanical stress on the filter material caused by the liquid being sprayed on it is only high enough to rule out damage to the filter material.

It is advantageous if the second drive is designed to move the high-pressure cleaning nozzle with a speed amounting to between 0.1 mm/s and 20 mm/s, preferably between 0.5 mm/s and 16 mm/s, and ideally between 1.0 mm/s and 12 mm/s. The values mentioned above ensure sufficient cleaning effectiveness of the high-pressure cleaning nozzle with a still acceptable mechanical stress of the filter material. Incidentally, the speed can be constant while the high-pressure cleaning nozzle is moving. It could also be conceivable to vary the speed depending on the distance separating the high-pressure cleaning nozzle(s) from the drum's rotation axis, increasing it for example when the movement takes place toward the rotation axis.

It is finally advantageous if the drum's driving device and the second drive of the high-pressure cleaning nozzle are synchronized in such a way that the relative speed between the high-pressure cleaning nozzle and a filter surface section cleaned by it while the corresponding filter surface is being cleaned by the high-pressure cleaning nozzle is at least 1.0 mm/s, preferably at least 1.5 mm/s, very preferably at least 2.0 mm/s and no more than 20 mm/s, preferably no more than 18 mm/s, very preferably no more than 16 mm/s. In this case, cleaning effectiveness is sufficiently high while ensuring that the surface section of the filter material being sprayed with liquid is not sprayed too long, thus reliably preventing damage or excessive wear of the filter material.

Additional advantages of the invention are described in the following embodiments, which show:

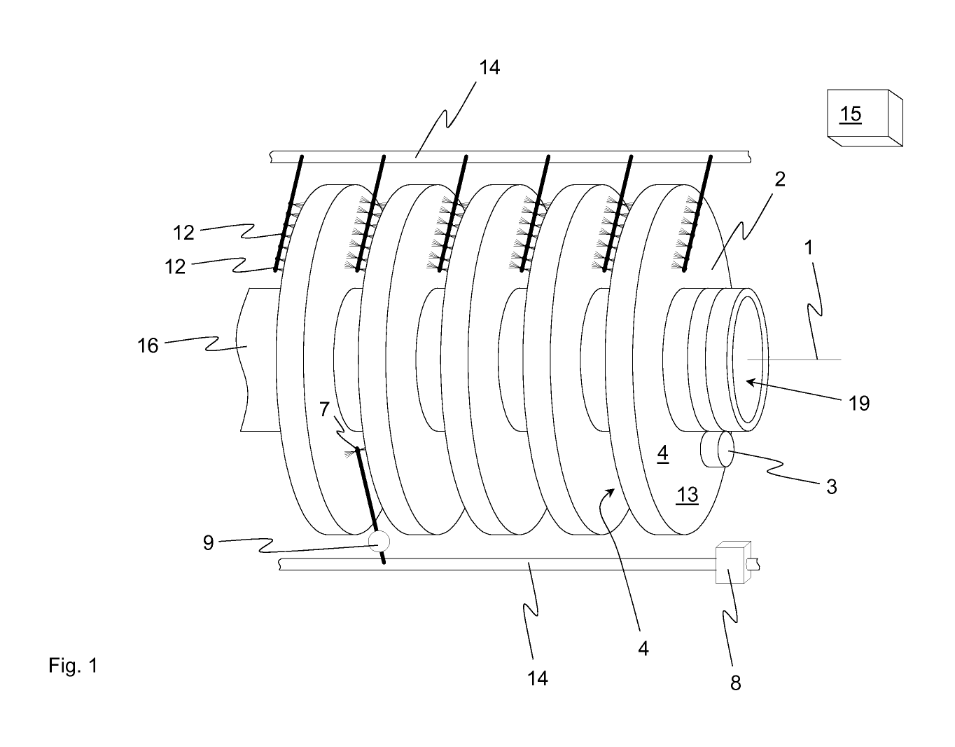

FIG. 1 a schematic top view of a section of a filter device according to the invention,

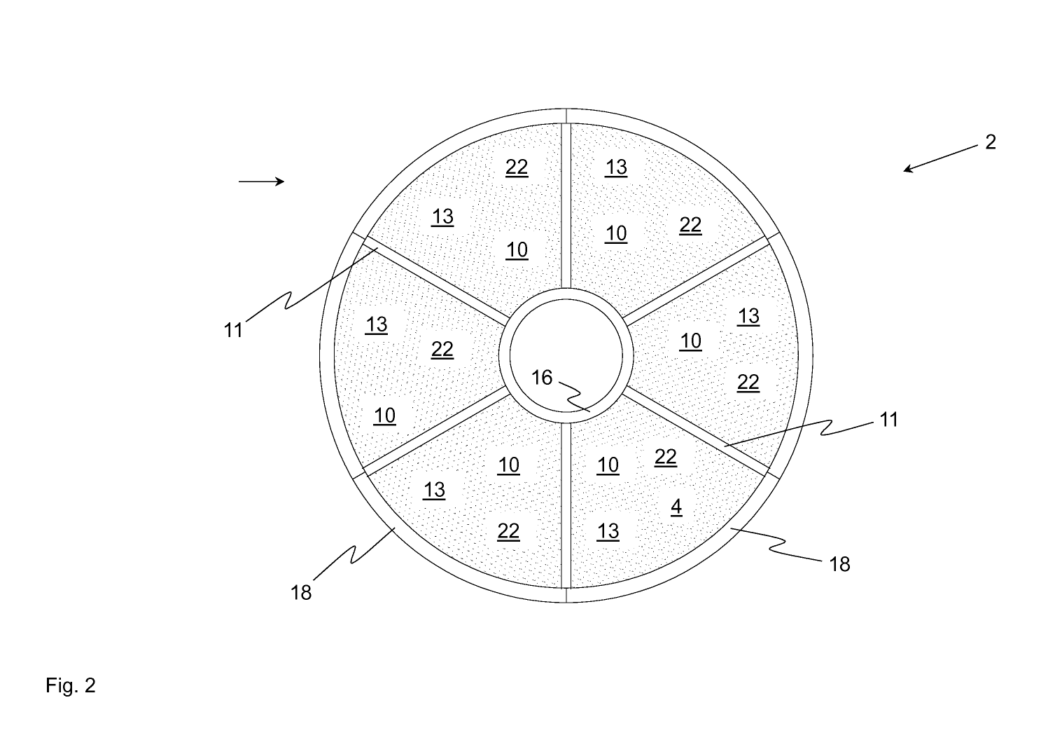

FIG. 2 a side view of a schematically shown filter disk according to the invention attached to a drum of a filter device,

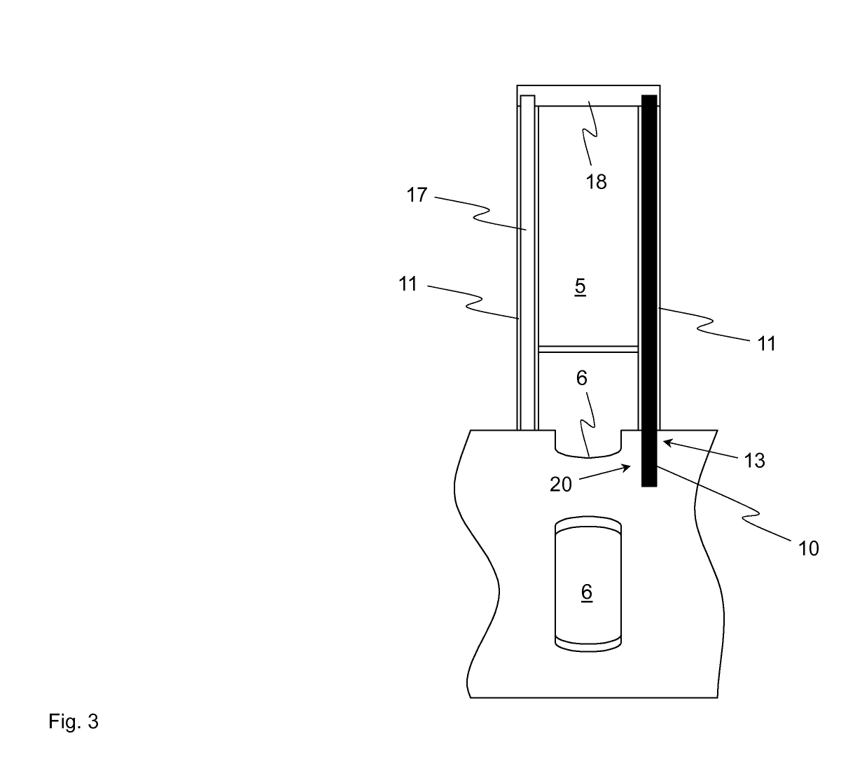

FIG. 3 a section of the drawing according to FIG. 2 with the direction of view indicated by a horizontal arrow in FIG. 2, and

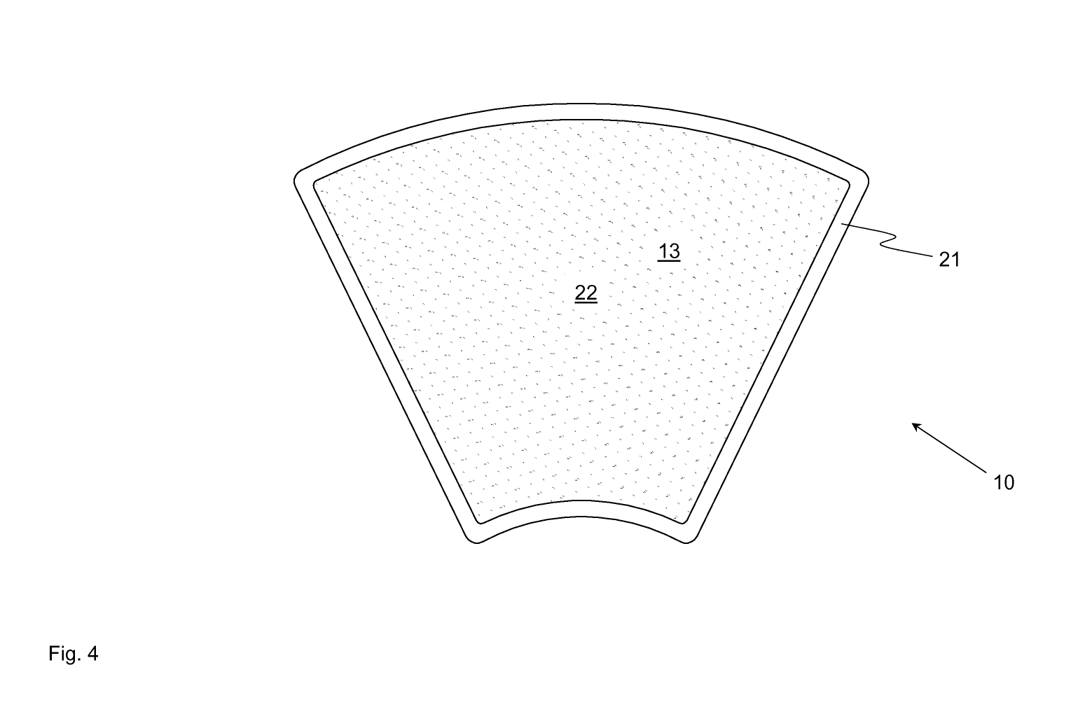

FIG. 4 a filter segment of a filter device according to the invention.

FIG. 1 shows a section of a schematic top view of a filter device according to the invention. In principle, the filter device comprises a centrally arranged drum 16 mounted with bearings (not shown) so it can move on a frame (not shown), whereby the rotation around a rotation axis 1 takes place with the help of the corresponding driving device 3.

Numerous filter disks 2 are attached to the outer perimeter of the drum 16 (however, for reasons of clarity, only one filter disk 2 is given a reference sign in FIG. 1). The filter disks 2 have in each case two filter surfaces 4 executed essentially in an annular shape that delimit an inner hollow space 5.

If sewage is now allowed to flow through the inlet 19 into the drum 16, then it can flow into the individual hollow spaces 5 through the respective inlet openings 6 placed between the two filter surfaces 4 of each filter disk 2. During the subsequent course, the filtrate passes the filter surfaces 4, starting from the hollow spaces 5 towards the exterior, and the filter surfaces 4 hold back most or all the impurities in the sewage. So that even the smallest impurities can be filtered out, according to the invention a filter material 22 is used that comprises a supporting layer and many individual fibers attached to the support layer, in which case and with regard to its possible structure, reference is made to the description provided above (in particular, the filter material 22 can also be provided as needle felting).

FIG. 2 shows a possible execution of a filter disk 2. As can be seen in this figure, the filter disk 2 can comprise numerous filter segments 10 held in the corresponding supports 11. Here, the supports 11 can extend radially towards the exterior starting from the drum 16. In addition, they should create two support assemblies arranged parallel to one another so that the filter segments 10 can be arranged in two circular rings running parallel to one another. FIG. 3 shows a view towards the horizontal arrow shown in FIG. 2, but except for one filter segment 10 (to the right in FIG. 3), all filter segments 10 shown in FIG. 2 or the supports 11 arranged to the left of the vertical middle axis in FIG. 2 left were not included so details of the visible support 11 could be shown. As can be seen in FIG. 3, the support 11 (which, by the way, can also be executed to have several parts) has two grooves 17 running parallel in which one filter segment 10 can be inserted and then they can be fixed in place by an outer cover element 18 (for reasons of clarity, not all cover elements 18 were given a reference sign).

The filter segments 10, one of which is shown in FIG. 4, comprise preferably in each case one supporting frame 21 and a flat filter material 22 attached (e.g. bonded or glued) to it. If the individual filter segments 10 are now inserted in the grooves 17 running parallel (cf. FIGS. 2 and 3), then the so-called hollow spaces 5 are finally created, into which the sewage can flow through the inlet openings 6 of the drum 16. Finally, the filtrate flows over the respective inner surfaces 20 of the filter material 22 and through it, coming out over its external surfaces 13 in the area between the filter disks 2 so it can be finally removed from the filter device. Naturally, the filter device has a housing in which the parts shown in the figures are located and serves to collect the filtrate. Incidentally, the filtrate has a gage that reaches all the way to the height of the rotation axis 1 of the drum 16.

Regardless of the exact design of the filter disks 2, the impurities in the sewage start collecting on the inner surface 20 or inside the filter material 22 after a certain filtration time has elapsed.

The filter device therefore comprises at least one high-pressure cleaning nozzle 7 (shown in FIG. 1) which, with the help of a first drive 8 (e.g. an electric drive that is operationally connected with a support 11 of the high-pressure cleaning nozzle 7 with a strap or chain), can be moved back and forth towards the rotation axis 1 of the drum 16, so that every one of the filter surfaces 4 can be adjusted little by little. Furthermore, a second drive 9 is assigned to the appropriate high-pressure cleaning nozzle 7 with which the high-pressure cleaning nozzle 7 can be moved towards and away from the drum 16 (the movement is radial with respect to the rotation axis 1, and the movement can take place on a straight or also crooked line).

If the high-pressure cleaning nozzle 7 is activated by a control 15, then it is adjusted with the help of the first drive 8 to a first filter disk 2 and then, when the filter disk 2 is rotating with the help of the second drive 9, it is moved slowly towards the drum 16 to spray the entire outer surface 13 of the contiguous filter material 22 with a cleaning liquid (preferably with filtrate) (to achieve this, the high-pressure cleaning nozzle 7 is connected to a supply of liquid 14 through which the cleaning liquid is supplied with the help of a respective liquid pump). Here, the cleaning liquid penetrates the filter material 22 so that adhered impurities can be flushed towards the hollow spaces 5. From there, they can finally fall downwards through the inlet openings 6 of the drum 16 and to its interior. If a collection device (not shown) is arranged in the interior of the drum 16 (a drain, for example), then the impurities are collected and can be removed from the filter device.

Moreover, the filter device can finally have a second cleaning assembly that comprises many low-pressure cleaning nozzles 12 (see FIG. 1; for reasons of clarity, not all low-pressure cleaning nozzles 12 have reference characters). While the high-pressure cleaning nozzles 7 have to be activated only rarely, it makes sense to activate the low-pressure cleaning nozzles 12 relatively often to counteract the penetration of impurities into the filter material 22. The low-pressure cleaning nozzles 12 can be fixed in place or swivel around an axis parallel to the rotation axis 1 and are preferably directed in such a way that they can spray the individual filter surfaces 4 in radial direction with cleaning liquid, so that the filter disks 2 are fully cleaned while they rotate.

With regard to the individual characteristics already described above and their advantageous further developments, we refer to the general description and the characteristics and further developments of the invention, which can become a reality in the embodiments shown, either individually or in any combination.

The present invention is not restricted to the embodiments shown and described. Variations within the framework of the patent claims are just as possible as any combination of the characteristics described, even if they are shown and described in different parts of the description, the claims or in various embodiments.

### LIST OF REFERENCE CHARACTERS

1 Rotation axis
2 Filter disk
3 Driving device
4 Filter surface
5 Hollow space
6 Inlet opening
7 High-pressure cleaning nozzle
8 First drive
9 Second drive
10 Filter segment
11 Support
12 Low-pressure cleaning nozzle
13 Outer surface
14 Supply of liquid
15 Control
16 Drum
17 Groove
18 Cover element
19 Inlet
20 Inner surface
21 Supporting frame
22 Filter material

1. Filter device for filtering sewage,
wherein the filter device has a drum (16) pivoted around a rotation axis (1),
wherein the filter device has numerous filter disks (2) running parallel to one another that are attached to the drum (16) and together with it can be made to rotate with the help of a driving device (3),
wherein the filter disks (2) have in each case two filter surfaces (4) running parallel to one another that delimit several hollow spaces (5) arranged in circumferential direction of the respective filter disk (2) and preferably in fluid connection with one another,
wherein the hollow spaces (5) are in fluid connection with the drum (16) through one or several inlet openings (6), so that the sewage to be filtered can flow starting from the interior of the drum (16) through the inlet openings (6) into the hollow spaces (5) and the filtrate can flow from there through the filter surfaces (4) to the exterior,
characterized in that
the filter surfaces (4) are formed, at least partially, by a filter material (22) that comprises a supporting layer and numerous individual fibers attached to the supporting layer, and that the filter device has at least one high-pressure cleaning nozzle (7) that can be moved towards the rotation axis (1) with whose help the outer areas (13) of the filter disks (2) facing away from the respective hollow spaces (5) can be sprayed with a liquid to clean the filter material (22) in reverse flow.

2. Filter device according to claim 1, characterized in that the filter material (22) is executed as needle felting.

3. Filter device according to one of the preceding claims, characterized in that the high-pressure cleaning nozzle (7) can be moved in the direction of the rotation axis (1) with the help of a first drive (8) and in a plane running perpendicularly to the rotation axis (1) with the help of a second drive (9), so that the filter material (22) of the individual filter disks (2) can be cleaned individually or successively in groups.

4. Filter device according to one of the preceding claims, characterized in that the filter material (22) comprises synthetic fibers, for example polyester fibers, polypropylene fibers and/or polyamide fibers, and that the filter material (22) is preferably mechanically reinforced.

5. Filter device according to one of the preceding claims, characterized in that the filter surfaces (4) comprise in each case several filter segments (10) arranged in circumferential direction of the filter disks (2), whereby the individual filter segments (10) comprise in each case one supporting frame (21) and a filter material (22) attached to the supporting frame (22).

6. Filter device according to one of the preceding claims, characterized in that additionally, the filter surfaces (4) are assigned in each case to one or several low-pressure cleaning nozzles (12), with whose help the outer surfaces (13) of the filter disks (2) facing away from the corresponding hollow spaces (5) can be sprayed with a liquid to clean the filter material (22) in reverse flow.

7. Filter device according to one of the preceding claims, characterized in that at least one low-pressure cleaning nozzle (12) is assigned to each filter surface (4), so that all filter surfaces (4) can be cleaned at the same time.

8. Filter device according to claim 6 or 7, characterized in that the high-pressure cleaning nozzle (7) and the low-pressure cleaning nozzles (12) are connected to one another with a supply of liquid (14), in which case the supply of liquid (14) is designed to supply the high-pressure cleaning nozzle (7) with a liquid pressure amounting to between 30 bar and 220 bar, preferably between 40 bar and 200 bar, ideally between 50 bar and 180 bar, and that the supply of liquid (14) is designed to impinge the low-pressure cleaning nozzles (12) with a liquid pressure amounting to between 1 bar and 25 bar, preferably between 1 bar and 20 bar, ideally between 1 bar and 15 bar.

9. Filter device according to one of the preceding claims, characterized in that the filter device has a control (15) designed to activate the high-pressure nozzle (7) and/or the low-pressure cleaning nozzles (12) only when the drum (16) and with it, the filter disks (2) too, can be rotated with the help of the driving device (3).

10. Filter device according to one of the preceding claims, characterized in that the filter device has a control (15) designed to activate the high-pressure nozzle (7) and/or the low-pressure cleaning nozzles (12) at the same time or in a time displaced way with regard to one another.

11. Filter device according to one of the preceding claims, characterized in that the filter device has a control (15) designed to reactivate the high-pressure nozzle (7) in 1 operating hour at the earliest, preferably in 3 operating hours at the earliest, ideally 5 operating hours at the earliest, after one high-pressure cleaning cycle has been completed, and/or that the control (15) is designed to reactivate the high-pressure cleaning nozzle (7) in 15 operating hours at the latest, preferably in 11 operating hours at the latest, ideally in 8 operating hours at the latest, after one high-pressure cleaning cycle has been completed.

12. Filter device according to one of the preceding claims, characterized in that the filter device has a control (15) designed to activate the high-pressure cleaning nozzle (7) at the earliest when the filter surfaces (4) were fully cleaned with the help of the low-pressure cleaning nozzles (12) 45 times, preferably 135 times, ideally 225 times, and/or that the control is (15) designed to activate the high-pressure cleaning nozzle (7) at the latest when the filter surfaces (4) were fully cleaned with the help of the low-pressure cleaning nozzles (12) 675 times, preferably 495 times, ideally 360 times.

13. Filter device according to one of the preceding claims, characterized in that the driving device (3) of the drum (16) is designed to rotate the drum (16), while the filter device is operating, with a speed amounting to between 0.5 rpm and 10.0 rpm, preferably between 1.0 rpm and 5.0 rpm.

14. Filter device according to one of the preceding claims, characterized in that the second drive (9) is designed to move the high-pressure cleaning nozzle (7) with a speed amounting to between 0.1 mm/s and 20 mm/s, preferably between 0.5 mm/s and 16 mm/s, ideally between 1.0 mm/s and 12 mm/s.

15. Filter device according to one of the preceding claims, characterized in that the driving device (3) of the drum (16) and the second drive (9) of the high-pressure cleaning nozzle (7) are geared to one another in such a way that the relative speed between the high-pressure cleaning nozzle (7) and a surface section of the filter material (22) cleaned by it while the corresponding filter surface (4) is being cleaned by the high-pressure cleaning nozzle (7) amounts to at least 1.0 mm/s, preferably to at least 1.5 mm/s, ideally to at least 2.0 mm/s, and/or that the relative speed between the high-pressure cleaning nozzle (7) and the surface section of the filter material (22) cleaned by it during the cleaning of the corresponding filter surface (4) by the high-pressure cleaning nozzle (7) is 20 mm/s at most, preferably 18 mm/s at most, and ideally 16 mm/s at most.
